(19) United States
(12) Patent Application Publication
(10) Pub. No.: US 2009/0003987 A1
(43) Pub. Date: Jan. 1, 2009

(54) Airfoil with improved cooling slot arrangement

(76) Inventors: Jack Raul Zausner, Niskayuna, NY (US); David James Walker, Burnt Hills, NY (US); Robert Francis Manning, Newburyport, MA (US)

Correspondence Address: GENERAL ELECTRIC COMPANY, GE AVIATION, ONE NEUMANN WAY MD H17, CINCINNATI, OH, 45215, US

(21) Appl. No.: 11/643,239

(22) Filed: Dec. 21, 2006

(51) Int. Cl. F02C 7/12; F01D 5/18

(52) U.S. Cl. 415/115; 416/97 R

(57) ABSTRACT

The present invention relates to airfoils, and in particular turbine blades and vanes, having cooling slots that are angled from a line of reference to effect metering of cooling air through the cooling slots thereof. This metered cooling airflow also creates a more stable film cooling layer about the surface of the airfoil.

### FIELD OF THE INVENTION

The invention relates to an airfoil with at least one slot for cooling a portion of the airfoil. More specifically, the invention relates to an airfoil having cooling slots where the inlet and outlet for each cooling slot are located at different radial positions along the radial length of the blade.

### BACKGROUND OF THE INVENTION

Gas turbine engines extract energy from a stream of hot combustion gases that flow through a flow path defined by the turbine. A typical turbine engine includes at least one stage of turbine blades and one stage of vanes spaced from the turbine blades. Each turbine stage comprises a plurality of turbine blades or airfoils spaced circumferentially around, and extending radially outward from, a rotatable hub or disk so that a portion of each turbine blade extends into the flow path and comes in contact with the flow of the combustion gases through the flow path. In practice, turbine engines comprise multiple stages of vanes and blades.

During engine operation it is necessary to cool turbine blades and vanes to improve their ability to endure extended exposure to the hot combustion gases. Frequently, blade cooling is achieved by creating a cooling film along the blade. In order to develop the desired cooling film, the turbine blades include one or more rows of spanwisely distributed cooling air supply holes, referred to as film holes and these holes are located along the surface of the blade. The film holes penetrate the walls of the airfoil to establish fluid flow communication between cooling fluid passing through the interior of the blade and the externally located hot combustion gases. Additionally, the blade includes a plurality of cooling slots spaced along the trailing edge of the blade. The slots are located within the blade and have outlet openings spaced along the trailing blade edge. During engine operation, cooling fluid or air is typically supplied to the blade by a compressor upstream of the airfoil compressor. The cooling air passes through the interior of the blade, including the slots, and exits the blade through the film holes and outlet openings. The cooling air flows from the holes and the cooling slots as a series of discrete jets. The air discharged from the slots and holes is intended to form the cooling film along the blade surface.

A conventional airfoil in FIG. 2 provides an example of a turbine blade 70 of the prior art. As shown in FIG. 2, the blade 70 includes leading edge 71, trailing edge 72 and a plurality of parallel cooling slots 75 at the blade trailing edge. In prior art blade 70, each of the cooling slots has an associated axially extending slot reference line 80. Each slot has an inlet 62 and an outlet 63. The outlet is located at the trailing edge of the blade. The inlet and outlet are located at substantially the same radial position along the radially extending blade length. For simplicity, in FIG. 2 reference lines 80 are provided for fewer than all of the slots however, the reference lines apply to all of the cooling slots 75. Each of the cooling slots is parallel to its respective reference line 80.

Film cooling provides an effective means for controlling the temperature of airfoil surfaces, however in practice, cooling films are difficult to effectively produce. One shortcoming associated with the conventional parallel cooling slot orientation is that the blade is susceptible to the backflow of combustion gases through the cooling slots. Backflow occurs when the static pressure of the cooling air does not exceed the static pressure of the combustion gases flowing through the flow path. When backflow occurs, the combustion gases flow through the cooling holes and into the cooling slots

In order to overcome the susceptibility to backflow in conventional blades, the high cooling air is discharged from the slots and holes at a high pressure to prevent backflow. The relatively high pressure cooling air can cause the cooling air to be discharged from the cooling slots with a velocity that prevents the cooling air from effectively adhering to the surface and edges of the airfoil. As a result, the desired cooling film does not form on the blade. Instead the cooling air is directly flowed into and entrained with the combustion gases. As a result, a portion of the blade airfoil surface immediately downstream of each cooling hole or cooling slot is exposed to the combustion gases and is not protected by a cooling film. Additionally, each of the cooling air jets may locally intersect and bifurcate the stream of combustion gases into a pair of minute, oppositely swirling vortices. The combustion gases enter the exposed portion of the airfoil and can cause irreparable damage to the airfoil. The intense heat of backflow gases can quickly and irreparably damage an airfoil.

What is therefore needed is an airfoil with cooling slots arranged in a manner that promotes effective formation of a cooling film along the airfoil surface.

### BRIEF DESCRIPTION OF THE INVENTION

An airfoil comprising a leading edge, a trailing edge, a blade tip at a first blade end and a blade root at a second blade end, the tip and root being separated by a radial distance, a cooling passage extending between the leading and trailing edges, and at least one cooling slot having an inlet end in fluid receiving communication with the cooling passage and an outlet end proximate the trailing edge, and wherein for the at least one slot the inlet and outlet are located at different radial locations within the airfoil.

Thus, by the described invention improved the cooling of an airfoil is achieved. This improvement is accomplished by metering airflow through a plurality of angled cooling slots. Also, instead of drilling cooling slots into an airfoil, one may cast cooling slots into an airfoil and thus decrease manufacturing costs and increase the beneficial variability of cooling slots at their creation.

### BRIEF DESCRIPTION OF THE DRAWINGS

While the specification concludes with claims particularly pointing out and distinctly claiming the invention, it is believed that the embodiments set forth herein will be better understood from the following description in conjunction with the accompanying figures, in which like reference numerals identify like elements and in which:

FIG. 1 shows a schematic representation of a gas turbine;

FIG. 2 is a sectional view of a prior art turbine blade comprising a conventional cooling slot configuration;

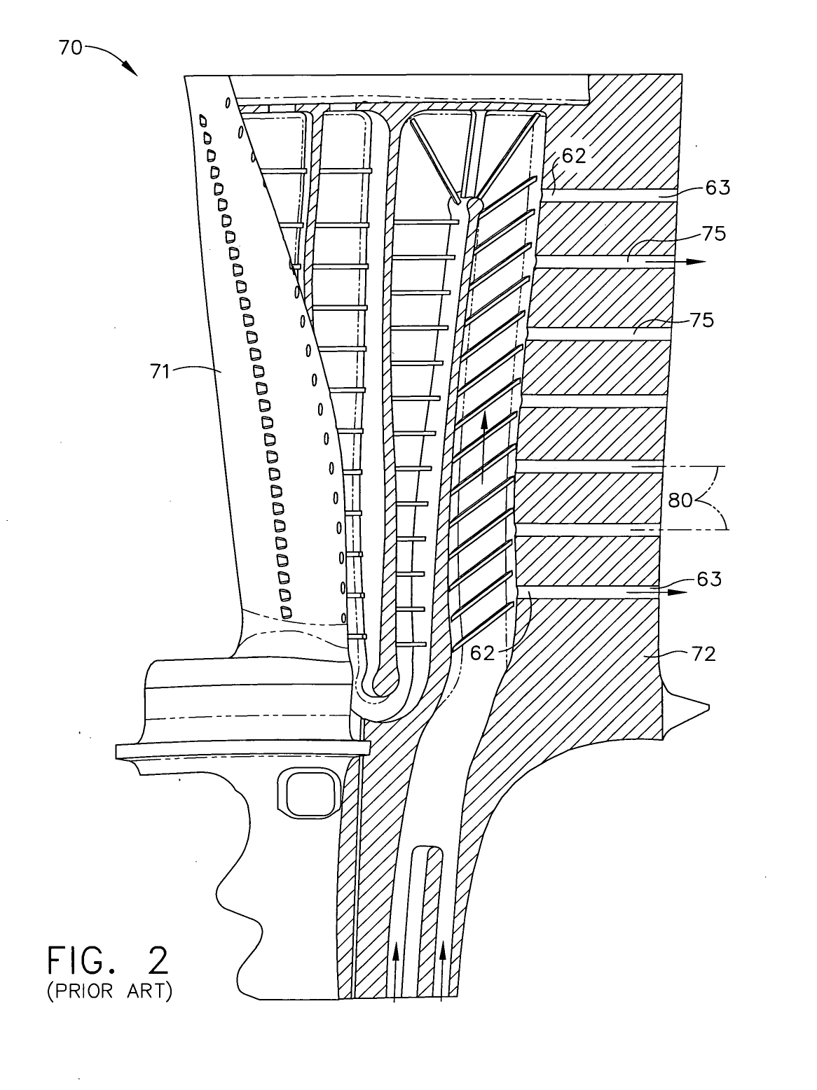

FIG. 3 is a sectional view of a turbine blade comprising a cooling slot arrangement according to an embodiment of the present invention;

FIG. 4 is a sectional view of a turbine blade comprising an alternate embodiment of the invention; and

FIG. 5 is an enlarged detailed view of the portion of FIG. 4 within the circle identified as 5.

### DETAILED DESCRIPTION OF THE SPECIFICATION

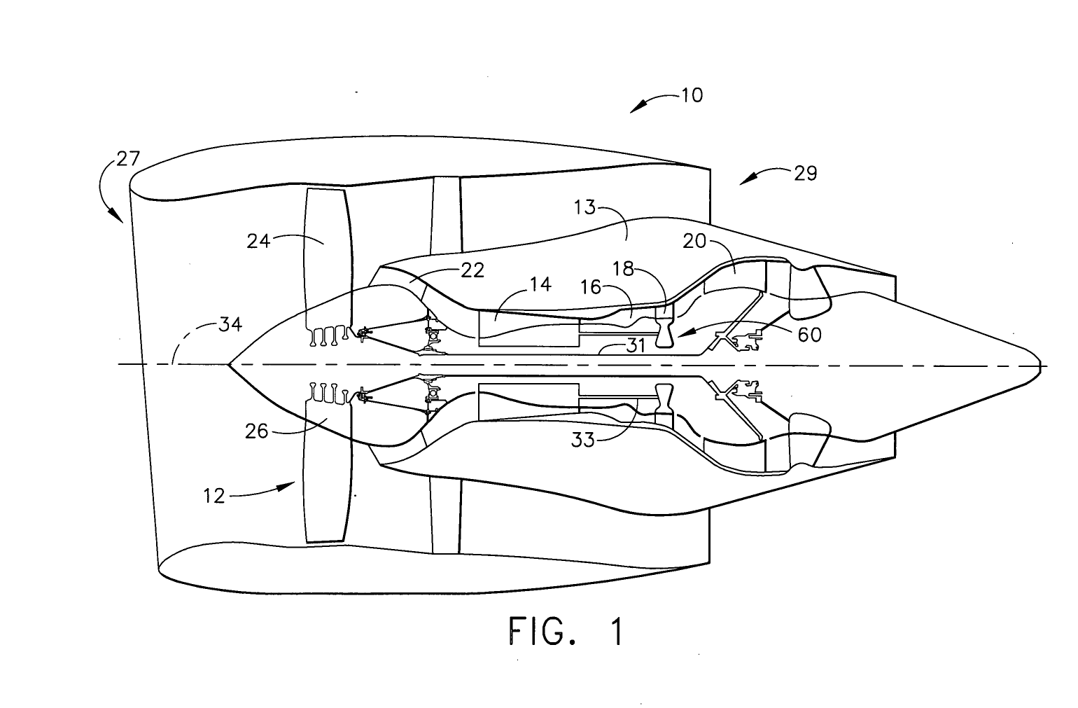

FIG. 1 is a schematic representation of an exemplary gas turbine engine 10. Engine 10 includes a fan assembly 12, a core engine 13, a high-pressure compressor 14, and a combustor 16. Engine 10 also includes a high-pressure turbine 18, a low-pressure turbine 20, and a booster 22. Fan assembly 12 includes an array of fan blades 24 extending radially outward from a rotor disc 26. Engine 10 has an intake side 27 through which air flows into and an exhaust side 29 through which air flows out of the engine. In one embodiment, the gas turbine engine is a GE90-115B that is available from General Electric Company, Cincinnati, Ohio. Fan assembly 12 and turbine 20 are coupled by shaft 31. Compressor 14 and turbine 18 are coupled by shaft 33.

During operation, air flows axially through fan assembly 12 in a direction that is substantially parallel to central axis 34 extending through engine 10. Compressed air is supplied primarily to combustor 16 by high-pressure compressor 14. Most of the highly compressed air is delivered to combustor 16. Airflow (not shown in FIG. 1) from combustor 16 drives turbines 18 and 20, and turbine 20 drives fan assembly 12 through shaft 31. High-pressure turbine 18 includes an array of blades 60.

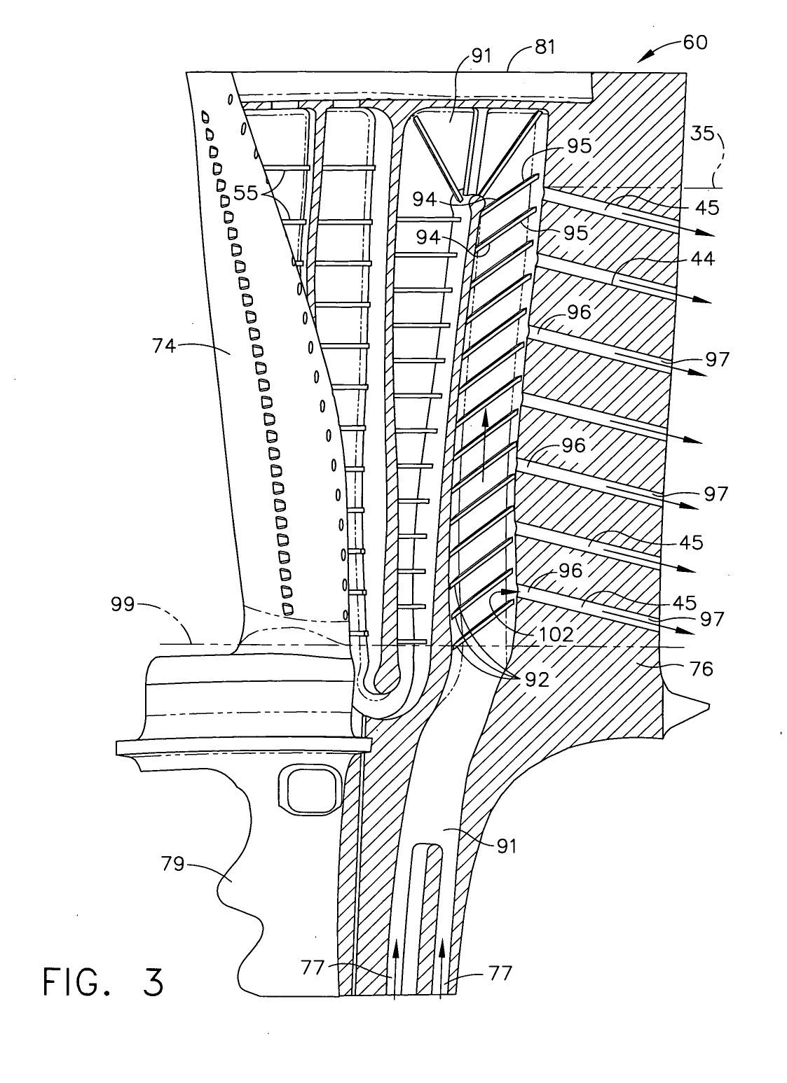

Blade or airfoil 60 is shown in greater detail in FIG. 3. Additionally the airfoil may be a vane. Airfoil 60 comprises leading edge 74, and a trailing edge 76 opposite the leading edge. The blade also comprises radially opposed blade tip 81 and root 79. The tip and root are separated by a radially extending distance. The blade is coupled with the rotor (not shown) at the root. Air flowing through the gas turbine engine along the flow path flows across the blade 60 in an axial direction from the leading edge 74 to the trailing edge 76. Compressed cooling air flows into the blade through openings at the leading edge 74 of the airfoil and also through inlet passages 77. The cooling air that flows through passages 77 flows radially outward toward blade tip 81. As the inlet passages extend toward tip 81, they combine into a single cooling passage 91. The cooling passage extends in a serpentine manner through the interior of the blade. As shown in FIG. 3, blade 60 includes two inlets but it should be understood that blade 60 may include any suitable number of inlet passages 77. Arrows in FIG. 3 generally represent the flow direction of cooling air within blade 60.

A plurality of spaced apart vanes 92 are located in cooling passage 91 between inlet passages 77 and tip 81. The vanes are oriented in a parallel array, with each vane being substantially parallel to the other vanes in the array. Each vane has a first end 94 and a second end 95. For each vane the first end 94 of each discrete vane is located closer to root 79 than second end 95 of the same vane. For each discrete vane each second vane end 95 is located closer to tip 81 than first vane end 94 for the same vane. The vanes are fixed to the wall that defines the portion of cooling passage 91 at the trailing blade edge. The vanes are oriented at an angle relative to generally axially extending axis 99. Each vane is oriented relative to axis 99 at an angle that is less than ninety degrees. By orienting the vanes in this manner, with the first and second ends for each vane at different radial locations, cooling air is more effectively directed into cooling slots 45.

As shown in FIG. 3, blade 60 includes a plurality of cooling slots 45. The cooling slots are oriented in a generally parallel array. For purposes of disclosing a preferred embodiment of the invention blade 60 comprises seven slots however it should be understood that any suitable number of slots 45 may be provided in the blade. Each slot has an inlet 96 and an outlet 97. The outlets 97 are located at the trailing edge 76 of blade 60. The slots are formed in the blade proximate the trailing edge. The inlet is in flow communication with the cooling slot 91 and cooling air in the cooling passage 91 enters the cooling slot through inlet 96. The slots 45 of blade 60 are of substantially constant radial dimension and the radial dimension may be a diameter for example. For each cooling slot, the outlet 97 is located closer to the root 79 than the slot inlet 96 for the same cooling slot. For each discrete slot, the slot inlet 96 is located nearer the blade tip 81 than the slot outlet 97 for the same cooling slot. As a result of positioning the inlet and outlet for each cooling slot at a different radial locations along the blade, the airfoil of the present invention more effectively produces a cooling film along the blade. More specifically, airfoil 60 more effectively forms a cooling film along the trailing edge 76 of the blade.

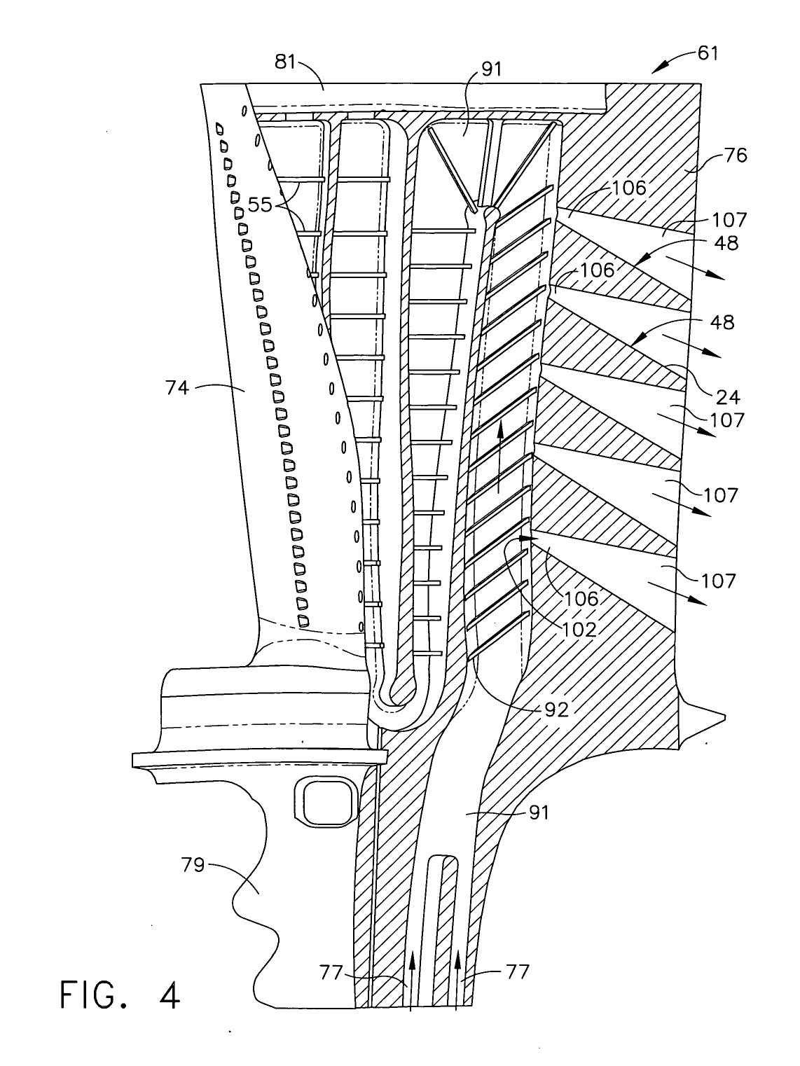

FIG. 4 discloses an alternate embodiment blade 61 that comprises slots 48, similar to slots 45. Slots 48 include inlet 106 and outlet 107. Like slots 45, the inlet and outlet for each slot is located at a different radial location along the blade with each inlet 106 located closer to tip 81 than outlet 107. The outlet 107 is located closer to root 79 than inlet 106. The radial dimensions for inlets 106 and 107 are not the same. As shown in FIG. 4, the inlet has a smaller radial dimension than the outlet. The radial dimension may be a diameter for example with the diameter of inlet 106 being smaller than the diameter of outlet 107. Blade 61 includes passages 77, 91 leading edge 74, trailing edge 76, tip 81, root 79 and vanes as described in blade 60.

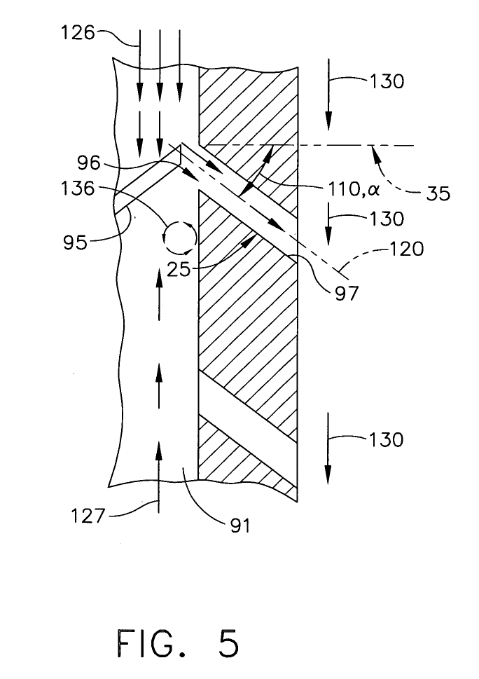

Note that unless specifically indicated to the contrary, as the description proceeds the description relating to slot 45 shall also apply to slot 48. For simplicity, the description shall refer to slot 45. As is shown in FIGS. 3 and 4, substantially all of the cooling slots 45, 48 may be oriented in a parallel array, at substantially the same angle Alpha (α) as shown in detail in FIG. 5. The angle alpha, identified at 110 is measured between reference line 35 and the central axis of slot 45. The central axis is identified as 120. The reference line 35 is substantially horizontal. In an alternate embodiment, fewer than substantially all of the slots may be arranged in parallel. For example, fifty percent of the slots may be arranged in parallel at the same angle 110. Angle 110 of cooling slot 45 is shown in which the angle is less than 90° and greater than 0°.

In practice, the flow of air through the cooling slot 45 of the present embodiment invention is distinguishable from the flow of air through conventional slots where the slot inlet and outlet are located at the same radial positions along the length of the blade. Cooling slots 45 minimize the mass flow of air through the slots 45 thus providing a controlled flow through the blade that is discharged from the slot outlet 97 at a velocity that is greatly reduced relative to prior art cooling slots. Such metered or controlled airflow creates a partial restriction of cooling air passing through the cooling slots 45. It should be understood that such restriction does not diminish the quality of the cooling layer formed on blade 60. Rather, the controlled, metered flow serves to enhance the formation of cooling film layer 30 and also to prevent both the escape of cooling air into the flow path of combustion gases and the formation of a backflow condition. By decreasing the cooling air mass flow through cooling slot 45 the velocity of the cooling air exiting the slots is reduced, thereby providing a cooler, slower moving boundary layer. As a result, upon exiting the slot the cooling air remains close to the surface and edges of turbine blade 60, ensuring that a suitable cooling layer is formed.

FIG. 5 provides a more detailed view of cooling airflow entering, traveling through and exiting cooling slot 45. Although the flow of cooling air entering, flowing through and exiting is only shown relative to one slot 45, the flow represents the flow for all slots 45 and 48. Cooling air flows to slot 45 through passage 91, from a first flow position 126 toward cooling slot inlet 96. Oppositely, cooling air flows through passage 91, in from second flow position 127 toward cooling slot inlet 96. First flow position cooling air enters the blade through openings at the blade leading edge 74 and passes through upstream portion of passage 91 toward the slots. As cooling air flows to the cooling slot from flow position 126 it may substantially move unobstructed into cooling slot 45. As cooling air enters from second flow position 127 the flow may be obstructed by one or more separation regions 136 created at or proximate cooling slot inlet 96. A separation region 136 occurs in a region adjacent cooling slot inlet 96. When cooling air from the flow position 127 approaches slot 45, cooling air from flow position 127 abruptly meets the flow 126, and thus creates one or more areas in which the air swirls or separates from its original flow stream, producing separation region 136.

In addition to the angled orientation of cooling slot 45, the separation region 136 can aid in metering the flow of cooling air through cooling slot 45 since it can at least partially block the flow of air from flow position 127 from moving into cooling slot 45. This prevents the formation of backflow as well as controlling the flow of cooling air into the slot. Cooling film layer 130 is formed by the cooling air exiting from cooling slot outlet 45. Cooling film layer 130 is formed on the leading edge 76 of blade 60 and serves to help cool the surface of turbine blade 60 and protect the blade against the harmful effects associated with hot combustion gases.

Cooling slot 45 is oriented at an angle 110 that may range from about 1 degree (1°) to about 88 degrees (88°). In another embodiment the angle 110 may range from about 10 degrees (10°) to about 75 degrees (75°). In still another embodiment the angle may range from about 20 degrees (20°) to about 60 degrees (60°) (30°) to about 50 degrees (50°).

The pressure ratio for each turbine blade 60 at the inlet 96 of each cooling slot 45 ranges from a pressure ratio of about 1.05 to about 2.0. The term “pressure ratio” means the ratio of the internal blade pressure to the external flow path pressure. It is desired to produce a pressure ratio greater than 1.0 since a pressure ratio lower than that would produce a backflow condition. Also, the movement of air within the airfoil through the cooling passage, slots and vanes is desired to have a Mach number ranging from about 0.03 Mach number to about 1.0 Mach number. The Mach number is defined as a ratio of the speed of an object or flow relative to the speed of sound in the medium through which it is traveling. In the present invention the Mach number falls into the desired range.

Additional benefits associated with the blade of the present invention include the fact that more cooling slots 45 can be used in engines having smaller turbine blades. By the term “smaller turbine blades” it is meant herein a turbine blade in an aircraft engine application in which the engine core flow rate is less than 13.61 kg/s at take-off power level. An exemplary engine having smaller turbine blades of the type discussed is a CT7 or T700 available from General Electric Company, Cincinnati, Ohio.

The blade of the present invention allows cooling slots 45 to be cast rather than drilled. The use of cast slots instead of drilled holes presents a significant cost savings in manufacturing, use of resources and material usage. In one embodiment, at least a portion of cooling slots 45 may be cast along trailing edge 76 of turbine blade 60.

Cooling slots 45 of the invention also allow for beneficial variability. The term “beneficial variability” means that one or more cooling slots 45 may have a varying diameter along its length and/or because of casting may have much larger diameters in comparison to drilled cooling slots 75. One example of beneficial variability is the use of larger holes, i.e., the exits of the cooling slots along the trailing edge of the turbine blades 70 (see FIG. 4). By having larger exit holes than those provided by drilling, e.g., laser drilling, greater cooling film coverage is achieved about the surface of turbine blade 60. Also, since outlets 107 can be made to be larger, than current slot technology, fewer cooling slots 45 may be used than in blades where constant radial dimension/diameter slots are used.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An airfoil comprising a leading edge, a trailing edge, a blade tip at a first blade end and a blade root at a second blade end, the tip and root being separated by a radial distance, a cooling passage extending between the leading and trailing edges, and at least one cooling slot having an inlet end in fluid receiving communication with the cooling passage and an outlet end proximate the trailing edge, and wherein for the at least one slot the inlet and outlet are located at different radial locations within the airfoil.

2. The airfoil of claim 1 wherein the radial dimensions of the inlet and outlet of the at least one cooling slot are substantially the same.

3. The airfoil of claim 1 wherein the radial dimension of the inlet and outlet of the at least one cooling slot are different.

4. The airfoil of claim 3 wherein the radial dimension of the inlet is less than the radial dimension of the outlet.

5. The airfoil of claim 1 wherein the at least one cooling slot is oriented at an angle of between from about 1 degree to about 88 degrees relative to a line of reference that is substantially parallel to an axially extending axis.

6. The airfoil of claim 5 wherein the at least one cooling slot is oriented at an angle of between from about 10 degrees to about 75 degrees.

7. The airfoil of claim 6 wherein the at least one cooling slot is oriented at an angle of between from about 20 degrees to about 60 degrees.

8. The airfoil of claim 7 wherein the at least one cooling slot is oriented at an angle of between about 30 degrees to about 50 degrees.

9. The airfoil of claim 1 wherein the airfoil comprises a plurality of cooling slots.

10. The airfoil of claim 1 wherein said airfoil is a turbine blade.

11. The airfoil of claim 1 wherein said airfoil is a vane.

12. The airfoil of claim 5 wherein fewer than all of the cooling slots are oriented at an angle of between from about 1 degree to about 88 degrees relative to a line of reference that is substantially parallel to an axially extending axis.

13. The airfoil of claim 12 wherein fewer than all of the cooling slots are angled ranging from about 10 degrees to about 75 degrees from said line of reference.

14. The airfoil of claim 13 wherein fewer than all of the cooling slots are angled ranging from about 20 degrees to about 60 degrees from said line of reference.

15. A gas turbine engine comprising a turbine with a plurality of airfoils, each of said airfoils comprising a leading edge, a trailing edge, a blade tip at a first blade end and a blade root at a second blade end, the tip and root being separated by a radial distance, a cooling passage extending between the leading and trailing edges, and at least one cooling slot having an inlet end in fluid receiving communication with the cooling passage and an outlet end proximate the trailing edge, and wherein for the at least one slot the inlet and outlet are located at different radial locations within the airfoil.

16. The gas turbine engine of claim 15 wherein the airfoil is a blade.

17. The gas turbine engine of claim 15 wherein the airfoil is a vane.

18. The gas turbine engine of claim 15 wherein the radial dimensions of the inlet and outlet of the at least one cooling slot are substantially the same.

19. The airfoil of claim 15 wherein the radial dimension of the inlet and outlet of the at least one cooling slot are different.

20. The airfoil of claim 15 wherein the at least one cooling slot is oriented at an angle of between from about 1 degree to about 88 degrees relative to a line of reference that is substantially parallel to an axially extending axis.
